(19) United States
(12) Patent Application Publication
(10) Pub. No.: US 2010/0307149 A1
(43) Pub. Date: Dec. 9, 2010

(54) HYDRODYNAMIC ENERGY GENERATION SYSTEM

(76) Inventor: James Kwok, Queensland (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/809,210

(22) PCT Filed: Dec. 19, 2008
(86) PCT No.: PCT/AU08/01888

§ 371 Date: Aug. 23, 2010

(30) Foreign Application Priority Data
Dec. 19, 2007 (AU) 2007906961
May 20, 2008 (AU) 2008902488

(51) Int. Cl. F03B 17/02

(52) U.S. Cl. 60/496

(57) ABSTRACT

An energy generation system comprising at least one shaft, buoyant means associated with, and movable relative to, said at least one shaft, wherein movement of the buoyant means relative to said at least one shaft causes rotation of the at least one shaft about a longitudinal axis, means for adding and/or removing a fluid to and/or from said buoyant means to cause movement of the buoyant means, and power generation means associated with said at least one shaft.

### FIELD OF THE INVENTION

The present invention relates to a hydrodynamic energy generation system. In particular, the present invention relates to a hydrodynamic energy generation system (or water pressure energy conversion system) that harnesses the buoyant properties of gas in a liquid medium.

### BACKGROUND ART

Traditionally, the generation of power, such as electrical power, has been achieved through the use of fossil fuels such as coal, natural gas and oil. However, in recent times, due to the decreasing reserves of fossil fuels and the environmental impact of their use in power generation, cleaner alternatives for the generation of power have become more popular.

Despite the fact that they are considerably more environmentally-friendly, these alternative power generation techniques (solar, wind, wave, geothermal etc) have struggled to gain widespread acceptance due to their inefficiencies in generating power, their high cost to establish in comparison to existing fossil fuel technology and their lack of aesthetic appeal (such as wind farms).

Therefore, there would be an advantage if it were possible to provide apparatus for power generation that efficiently generated power without having a detrimental impact on the environment.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

It is an object of the present invention to provide an energy generation system which may overcome at least some of the abovementioned disadvantages, or provide a useful or commercial choice.

In a broad aspect of the invention there is provided an energy generation system comprising at least one shaft, buoyant means associated with, and movable relative to, said at least one shaft, wherein movement of the buoyant means relative to said at least one shaft causes rotation of the at least one shaft about a longitudinal axis, means for adding and/or removing a fluid to and/or from said buoyant means to cause movement of the buoyant means, and power generation means associated with said at least one shaft.

In one aspect of the invention there is provided an energy generation system comprising a vessel, the vessel being at least partially filled with a first fluid, at least one shaft located within said vessel, buoyant means associated with, and movable relative to, said at least one shaft, wherein movement of the buoyant means relative to said at least one shaft causes rotation of the at least one shaft about a longitudinal axis, means for adding and/or removing a second fluid to and/or from said buoyant means, the second fluid having a density different to that of the first fluid, and power generation means associated with said at least one shaft.

In a preferred embodiment of the invention, the rotation of the at least one shaft about a longitudinal axis results in the generation of power by the power generation means.

The first and second fluids may be any suitable fluids, provided that the density of the second fluid is different to that of the first fluid. Typically, the density of the second fluid will be less than that of the first fluid, but it is to be appreciated that the difference in the respective densities of the fluid is useable to cause movement of the buoyant means. The first and second fluids may be liquids, gases or solutions, or a combination thereof. In a preferred embodiment of the invention, the first fluid is water (either fresh water or saltwater) and the second fluid is air.

It is preferred that the buoyant means moves relative to the shaft and the shaft rotates in position. Upon addition of the second fluid to the buoyant means, the buoyancy of the buoyant means within the denser first fluid increases, and the buoyant means moves upwardly in the vessel. As the second fluid is removed from the buoyant means, the buoyancy of the buoyant means decreases and the buoyant means move downwardly in the vessel. The buoyant means may comprise any suitable means, however it is preferred that the buoyant means comprises an inflatable vessel. In a preferred embodiment of the invention, the buoyant means is watertight and airtight to prevent leakage of the second fluid into the vessel and leakage of the first fluid into the buoyant means.

As previously stated, the buoyant means is associated with the at least one shaft. The buoyant means may be connected to the shaft using any suitable technique. However, in a preferred embodiment of the invention, the buoyant means is constructed to be substantially cylindrical, toroidal or any other similar shape with a hollow central passageway. In this embodiment, the shaft is adapted to pass through the hollow central passageway of the buoyant means.

In some embodiments of the present invention, there may be a plurality of buoyant means associated with one or more shafts.

Movement of the buoyant means relative to the at least one shaft in any direction may cause rotation of the at least one shaft. Suitably, either the buoyant means, the at least one shaft, or both are adapted to enhance the rotation of the at least one shaft. In one embodiment of the invention, the buoyant means comprises one or more engagement means adapted to engage the at least one shaft and cause rotation thereof as the buoyant means moves relative to the at least one shaft. The engagement means may be of any suitable form, although in a preferred embodiment of the invention the engagement means comprises one or more projections adapted to engage the surface of the shaft. Preferably, the one or more projections are shaped so as to cause the shaft to rotate as the buoyant means moves relative to the shaft.

In some embodiments of the invention, the one or more projections may engage with a complimentary portion of the outer surface of the shaft. The complimentary portion of the outer surface of the shaft may be of any suitable form that enhances the rotation of the shaft as the buoyant means moves relative to the shaft. In some embodiments of the invention, the outer surface of the shaft may be provided with grooves, channels, rifling or the like. In an alternative embodiment of the invention, the outer surface of the shaft may be provided with one or more continuous helical channels that extend along at least a portion of the length of the shaft. In this embodiment of the invention, the one or more projections of the buoyant means engage with the one or more helical channels of the shaft. As the buoyant means moves relative to the shaft, the shaft rotates. Each of the at least one shafts may have one' or more buoyant means associated with it.

The buoyant means may be of any suitable construction. However, it is preferred that the buoyant means is constructed so as to be buoyant when at least partially filled with the second fluid, and to be denser than the first fluid when the second fluid is removed. In this way, the buoyant means can be made to move both upwards, or downwards under gravity in the vessel depending on the quantity of the second fluid contained therein. The buoyant means may be constructed as a flexible, inflatable capsule or may be a rigid container, or it may be a combination of the two. Preferably, the buoyant means is shaped so as to reduce drag as it moves through the first fluid in the vessel. By controlling the movement of the buoyant means within the vessel, the rotation of the shaft can be maintained substantially continuously if required, meaning the power may be generated on a continuous basis by the power generation means. In a preferred embodiment of the invention, the size of the buoyant means is determined in accordance with buoyancy formulae based on, for instance, surface area, and the density of the first fluid.

Downward movement of the buoyant means in the vessel may be achieved under gravity. However, in some embodiments of the invention, the buoyant means is provided with weights, such as ballast, to assist in generating a downwards movement of the buoyant means through the vessel. The weights may be of any suitable type, although in some embodiments of the invention, the weights are constructed of stainless steel, or similar corrosion-resistant materials, due to their exposure to the first fluid contained within the vessel. The mass of the weights may be determined by the torque required to actuate an alternator and therefore generate electricity.

In other embodiments of the invention, the movement of the buoyant means relative to the shaft may be used to generate power. In these embodiments of the invention, either the weights may act as a rotor and the shaft as a stator, or vice versa. Any suitable rotor/stator arrangement may be used, such as, but not limited to, the shaft being provided as a permanent magnet or with magnetic portions and the weights/buoyant means being provided as or with one or more electromagnetic coils. In this way, as the weights move relative to the shaft, an electrical current may be generated.

Alternatively, the buoyant means may be provided with magnetic means and one or more coils through which the buoyant means can travel on their reciprocation may be provided. Typically the coils will be mounted coaxially with the shaft.

This electrical current may be used within the energy generation system, or may be used in one or more other applications external to the energy generation system.

In some embodiments of the invention, the buoyant means is provided with guide means for assisting with the smooth movement of the buoyant means relative to the shaft. The guide means may be any suitable means, such as a guide pole located parallel to the shaft. Preferably, the buoyant means is provided with engagement means of any suitable form adapted to engage the guide means and assist in the smooth movement of the buoyant means. The guide means and the engagement of the buoyant means with the guide means will preferably prevent the buoyant means from rotation, thereby assisting in the forced rotation of the at least one shaft.

Preferably, one end of the shaft is associated with power generation means. The other end of the shaft may be suitably connected to the ceiling or floor of the vessel, although it is not essential that the other end of the shaft be fixedly attached to a surface of the vessel. However the shaft is connected, it is essential that the shaft is able to freely rotate about a longitudinal axis within the vessel. In a most preferred embodiment of the invention, the shaft is connected at the base of the vessel to a support, such as a bearing, while the other end of the shaft is associated with power generation means located at the top of the vessel.

The vessel may be of any suitable form, such as, but not limited to, a tank. The exact dimensions of the vessel are not of particular importance to the working of the present invention. Alternatively, it will be appreciated that the vessel could equally be a water tower, mine shaft, or a tube or cylinder submerged in a body of water, such as a lake or ocean, or any other location or device in which a fluid may be contained.

The means for adding and/or removing the second fluid to and/or from the buoyant means may be of any suitable form. However, in a preferred embodiment of the invention the power generation system is provided with at least one reservoir in which the second fluid may be stored. The at least one reservoir may be of any suitable construction, shape or size provided that it may contain the required volume of second fluid. In a preferred embodiment of the invention, the power generation system is provided with two reservoirs. In this embodiment, a first reservoir is located in a lower portion of the vessel, and a second reservoir is located in an upper portion of the vessel. More preferably, the second reservoir is located level with, just above, or just below the surface of the first fluid in the vessel. The at least one reservoirs of the present invention may be provided either internally or externally to the vessel.

In embodiments of the invention in which two reservoirs are present, the first reservoir may be adapted to draw the second fluid from a source external to the vessel. If, for instance, the second fluid is a gas, the gas may be drawn from a gas generation system, gas cylinders, gas blowers, fans or the like. If the second fluid is air, it may be drawn directly from the atmosphere.

Preferably, the buoyant means is in fluid communication with both the first and second reservoirs. In a further embodiment of the invention, the first and second reservoirs may also be in direct fluid communication with one another. The fluid communication between the reservoirs, and between the reservoirs and the buoyant means may be achieved using any suitable method, such as by supplying pipes, hoses, conduits or any other suitable device through which the second fluid may flow. Preferably, the energy generation system is provided with flexible hoses through which the second fluid may flow. The hoses may be fabricated from any suitable material. However, in a preferred embodiment of the invention, the hoses may be constructed from a durable, corrosion-resistant material. Such material may include plastics, such as, but not limited to, polypropylene.

In some embodiments of the invention, the energy generation system may be provided with one or more housing means for the pipes, hoses, conduits or the like. The housing means may be of any suitable type. Preferably, the housing means may be adapted to ensure that the pipes, hoses, conduits or the like are prevented from becoming entangled with the shaft and/or the moving buoyant means.

In an alternative embodiment of the invention, the energy generation system may be provided with one or more docking means. The docking means may be associated with at least one of the first and second reservoirs. The docking means may be adapted to engage with the buoyant means as it moves within the vessel. As the buoyant means comes into contact with the docking means, the second fluid may be transferred directly to or from the buoyant means to a reservoir, eliminating the need for pipes and/or hoses through which the second fluid may flow. The docking means may be of any suitable construction provided that they are adapted to actuate only when the buoyant means is in contact with the docking means.

The second fluid may flow between the first reservoir and the buoyant means using any suitable method. However, in a preferred embodiment of the invention, the first reservoir is provided with means for forcing the second fluid into the buoyant means. Preferably, the means for forcing the second fluid into the buoyant means comprises one or more pistons. As the second fluid is forced into the buoyant means, the buoyant means become buoyant and rise through the vessel. At the upper limit of travel, the second fluid may be removed from the buoyant means. Fluid removed from the buoyant means preferably flows to the second reservoir, although it may equally pass directly to the atmosphere (such as by being vented through the top of the vessel).

Removing the fluid from the buoyant means causes the buoyant means to travel downwards through the vessel under gravity.

Fluid removed from the buoyant means may be stored in the second reservoir. In various embodiments of the invention, the fluid in the second reservoir may be vented to the atmosphere to reduce the fluid pressure in the second reservoir, or may be returned to the first reservoir in order to equalize pressure and to reduce the amount of fluid that must be drawn from outside the vessel in preparation for the next inflation of the buoyant means.

In an alternative embodiment of the invention, the flow of fluid between the reservoirs, and/or between the reservoirs and the buoyant means is achieved by taking advantage of the differences in pressure that arise between the reservoirs due to their relative positions within the vessel. For instance, due to its position at the bottom of the vessel, the fluid in the first reservoir will have a higher pressure than that of the buoyant means. Thus, when the valve between the first reservoir and the buoyant means is actuated, fluid flow between the relatively high pressure first reservoir and the relatively low pressure buoyant means will naturally occur. Similarly, when the second fluid is to be transferred from the relatively high pressure buoyant means to the relatively low pressure second reservoir, the actuation of the valve between the buoyant means and the second reservoir will naturally result in the flow of fluid between the relatively high pressure buoyant means and the relatively low pressure second reservoir. In this way, minimal energy is required to be added to the hydrodynamic energy generation system from an external energy source.

Actuation of the valves in the reservoirs may be achieved using any suitable technique, such as by providing an external power source (e.g. batteries, mains power, generators, solar cells, a flywheel system or the like, or any combination thereof). Preferably, however, the power source used to actuate the valves is chosen so as to minimize the requirement to use external energy (i.e. energy not generated by the system) or parasitic energy.

In some embodiments of the invention, at least one of said first and second reservoirs are provided with one or more pistons. In this embodiment of the invention, actuation of said one or more pistons in a first direction may force fluid out of the reservoir and into the buoyant means, while movement of the one or more pistons in a second direction may result in fluid being drawn out of the buoyant means and into the reservoir.

In a preferred embodiment of the invention, both of said reservoirs are provided with one or more pistons. Separate actuators may be provided for each of the reservoirs, or actuators common to both reservoirs may be used. In some embodiments of the invention, the actuation of a piston associated with one reservoir to force liquid out of that reservoir may simultaneously actuate a piston associated with the other reservoir to draw liquid into that reservoir. In this embodiment of the invention, a reciprocating ram (or “reverse thruster”) may be used to cause the simultaneously actuation of the pistons, although a skilled addressee will understand that any other suitable technique may also be used.

In a preferred embodiment of the invention, all of the pipes, hoses or conduits interconnecting the reservoirs and/or interconnecting the reservoirs and the buoyant means are provided with one or more means to allow the flow of fluid in one direction only. The means may be of any suitable type, such as one-way or non-return valves.

The power generation means may be of any suitable form. Preferably, the shaft is in communication with the power generation means such that rotation of the shaft results in activation of the power generation means. The power generation means may be of any suitable form, such as, but not limited to, one or more generators, turbines, or flywheel systems. Any suitable device or technique may be used to transfer the rotational energy of the shaft to the power generation means. However, in a preferred embodiment of the invention, a ratchet-cog system is used to transfer the rotational energy of the shaft to the power generation means. Normally the ratchet-cog system will prevent rotation of a shaft in at least one direction.

The energy required to drive the one or more pistons of the first reservoir and/or actuation of the non-return valves on the fluid lines interconnecting the reservoirs and/or the reservoirs and the buoyant means may be provided from any suitable energy source, such as mains power, batteries, generators and the like. However, in a preferred embodiment of the invention, the power generation system is provided with at least one solar energy collection device. In this embodiment of the invention, the solar energy collection device may provide at least a portion of the energy required to drive the one or more pistons and/or the one or more valves. In this way, the energy require represents a parasitic energy.

The surface area of the one or more pistons may be determined as a function of one or more of the following variables: the volume of the second fluid to be transferred, the density of the first fluid, the distance between the reservoir and the surface of the first fluid and so on.

Calculations for the design of the energy generation system (including a summary of the power output generated by an energy generation system) according to an embodiment of the invention are set out below in Tables 1 and 2.

TABLE 1
Hydrodynamics Capsule-Bouyant Calculation.

| | Water Pressures | | |
|---|---|---|---|
| Computational | Energy Conversion | (Energy and Mass Balance: | |
| Fluid Dynamics | CLEAN ENERGY GENERATION | N [symbol] PROD [symbol] OUT [symbol] ACC) | k- |

| Item | Description | Dia | Int | Ext | Length | Area m2 | Vol. m3 | Vol. ltr | Vol. ml | Pt | rad. | | bouyant |
|---|---|---|---|---|---|---|---|---|---|---|---|---|---|
| | mm | 295 | [symbol] | 295 | 435 | | 0.0284 [symbol] 5347 | 2 [symbol] .43534 [symbol] 53 | | 3.14 | 145 | 0.145 | 255 |
| | m | 0.295 | 0.29 | 0.295 | 0.435 | [symbol] | 0.02871 [symbol] | 33.3183475 | 28. [symbol] | | 0.021025 | r2 | 0.25 |
| | (Note-Bouyant | | | | | | [symbol] Check | [Check | | | | | |
| | Speed | | | | | | Y/N [symbol] | Y/N [symbol] ] | | | | | |
| | Required [symbol] ) | | | | | | | | | | | | |

Hydrodynamics Capsule Downward Force and Power Output

| | | | | | | | | | Torque | ZMass- | | | k- |
|---|---|---|---|---|---|---|---|---|---|---|---|---|---|
| Item | Description | Dia | Int | Ext | length | Area m2 | Vol. m3 | Vol. ltr | [symbol] | kg | RhoMass kg | V-m/s | friction |
| | mm | 250 | 0 | 250 | 61.75 | | 0.002 [symbol] 75 | 2. [symbol] 75 | 0. [symbol] | 23 | 21. [symbol] 00473 | 10 | 25% |
| | m [Note-Shell | 0.25 | 0 | 0.25 | 0.05 [symbol] 75 | 0.0490625 | 0.00302950 [symbol] | 3.029589375 | HP-KW | RPM- | Time; t-sec | Rho | rhogen |
| | Exploded | | | | | | | | | rpm | | Capsule | |
| | Weight [symbol] | | | | | | | | | | | | |
| | Total | Rho(−10%) | Rho | [symbol] M [symbol] kgm/s | Friction | [symbol] | Z Power-HP | Z power [symbol] kW | 0.74 [symbol] | 2930 [symbol] | 25 | 8000 | XX |
| | Downwards | | Liquid | | Loss | | | | | | | | |
| | Force | | | | | | | | | | | | |
| | [symbol] Force [symbol] | [symbol] /m3 | 1.010 | 2 [symbol] 0 | 4.6 | 225.4 | 1496.38538 [symbol] | 1114.807114 | | [symbol] | | kg/m3 | |
| | and kN; | | | | | | | | | | | | |
| | Rho in kg/m3; | [symbol] = Watt | | Net [symbol] M-Nm/s | 2 M-Nm | | | | | [symbol] -Py | | 1 | |
| | N/m3 [symbol] = Pa; | | | | | | | | | | | | |
| | kN/m2 [symbol] kPa | Nm = Joule | | [symbol] 229.206 | [symbol] 573.01 [symbol] | | | [symbol] -friction | k- | [symbol] | Hose Dia | Hose [symbol] | Noule m2 |
| | for | | | | | | | | boutant | | | | |
| | pressure | | | | | | | | | | | | |

| | | |
|---|---|---|
| [symbol] Liquid varies | [symbol] | Shape/A [symbol] |
| on medium used/ | | |
| applied [symbol] | | |
| Momentum [symbol] | | |

Hydrodynamics Bottom Reservoir and Pressure Power Input

| | | | | | | | | | Hose | Hose A [symbol] |
|---|---|---|---|---|---|---|---|---|---|---|
| Reservoir | Dia | Int | Ext | Length | Area m2 | Vol. m3 | Vol. ltr | [symbol] sec | Dia | m2 |
| mm | 3.2 [symbol] | 319 | 320 | 355 | | | | 3 | | |

| | | | | | | | | | | | |
|---|---|---|---|---|---|---|---|---|---|---|---|
| m | 0.32 | 0.3 [symbol] 9 | 0.32 | 0.355 | 0.079 [symbol] | 0.02835 [symbol] | [symbol] 455 [symbol] | [symbol] m/s | Bouyant-P [symbol] Pres [symbol] | E Height [symbol] m | [symbol] A-m2 |
| | | | | | | | | | Gradient Force = N | | |

| | | | | | | | | | |
|---|---|---|---|---|---|---|---|---|---|
| | | 0.0 [symbol] 46 [symbol] 347 | 28. [symbol] | 0.13 [symbol] | 16270. [symbol] 593 | 3825.74058 | 245 [symbol] | 34.645 | 0.0650185 |
| Dia | SO [symbol] | | | | | [symbol] Delta PG [symbol] | | | 295 |

| Water/ | | | | | | Height | | Vol. | | rho | | |
|---|---|---|---|---|---|---|---|---|---|---|---|---|
| Liquid Tower | Dia-m | Sides [symbol] 2 | Sides [symbol] | Area m2 | Area m2 | m | Vol.-m3 | [symbol] | Force [symbol] N | Liquid is | [symbol] -m3 | 0.295 |
| mm | 5 [symbol] | 900 | 500 | [symbol] VALUE [symbol] | | | | | | 1.01 | | |
| m | [symbol] VALUE [symbol] | 0.9 | 0.6 | [symbol] VALUE [symbol] | 0.54 | 25 | 13.5 | 1.3500 | [symbol] | | | |

| | | | 2 Pres | ZForce | | Power | Parasitic- | Parasitic#- | Z | | 2 |
|---|---|---|---|---|---|---|---|---|---|---|---|
| Reservoir Piston | Dia | Area [symbol] m3 | in M | in [symbol] | ZF [symbol] Nm/s | Kw | kW | % | Pressbars | [symbol] | pa-N/m2 |
| mm | 323 | | At piston [symbol] | >>>> | at Pstn Vel | [symbol] | | | 25 | 10000 | 25000 |
| m | 0.32 | 0.0 [symbol] 038#z,899; | | 20.03 [symbol] | 2378 [symbol] | 2.37 [symbol] 7 | 2.378026667 | 0. [symbol] 213313 | | | |

Total Power Output (kW).

| Total Gross | | | | | | | | | | | | | |
|---|---|---|---|---|---|---|---|---|---|---|---|---|---|
| Power/Capsule | 11 [symbol] 4.807 [symbol] 14 | Capsules | Gen RPM | F/W RPM | F/W M [symbol] kg | [symbol] | Velocity [symbol] m/s | [symbol] | F/W Dia-m | F/WAream2 | F/W Vol [symbol] m3 | [symbol] /m3 | length m |
| Parasitic | 2.3 [symbol] 6667 | S Active | | [symbol] .42675 | 23 | 1150 | [symbol] | 2.5 | 0.335 | 0.0143 [symbol] 63 | 0.003 [symbol] | 8000 | 0.27 |
| Power/Capsule | | | | | | | | | | | | | |
| Nett Power | 1112.4290 [symbol] 7 | 1 Stand | Gen-Output | | | | | | F/w [symbol] W k [symbol] | F/W [symbol] -Trq | F/WTra/Rw | | [symbol] 2-F/Ws |
| Output | | By | | | | | | | | | | | |
| Tot PowerO/put | [symbol] VALUE [symbol] | | Gen Pulley- | Gen | | | | | 23 | | | | |
| [symbol] -Caps | | | mm | Pul [symbol] m | | | | | | | | | |
| Correction | 2.378026667 | | 30 | 0.03 | | | | | F/Wp-Alt | | | | |
| Factor | | | | | | | | | | | | | |
| on Reclp | | | | | | | | | | | | | |

| | | | | | | | | | | |
|---|---|---|---|---|---|---|---|---|---|---|
| Total Capacity | [symbol] VALUE [symbol] | Nom. | CapPulleymm | Cap [symbol] Plly , | CP 2P [symbol] R | [symbol] k Dia | Req RPM | Ratio/ | Tot T-sec | HP- [symbol] |
| Output ( [symbol] Cps) | | | | | | | AC [symbol] | W-A [symbol] | | |
| Continuous | 111 [symbol] .4 [symbol] 90 [symbol] 7 | Nom. | 100 | 0.1 | 0.314 | 0.03 | 3900 | | | 2HP = 0.745kWM |
| Capacity | | 1 MW | | | | | | | | |
| ( [symbol] Cp) | | | | | | | | | | |

| | | | |
|---|---|---|---|
| [symbol] Dia | 63 [symbol] 9.426752 | [symbol] | [symbol] |

[symbol]

indicates data missing or illegible when filed

TABLE 2

| Hydrodynamic Energy Generation | | | Capsule Transverse Downwards as Power #z,899; | |
|---|---|---|---|---|
| [symbol] ower-Cycle Chart | | | | |
| Capsule Downwards [symbol] - [symbol] No-Power. | | | Capsule Transverse Upwards | |
| [symbol] ower-Stroke | | | | |
| | | | | [symbol] |
| | [symbol] | [symbol] | | |
| Capsule 1 | | | | [symbol] |
| | | | | Upwards [symbol] |
| | | | | 4 |
| | [symbol] | [symbol] | | |
| Capsule 3 | | | | [symbol] |
| | | | | Downs [symbol] |
| Capsule 3 | N/A | | | |
| Capsule 4 | N/A | | | |
| Capsule 5 | N/A | | | |
| Capsule 6 | N/A | | | |
| Total Power- [symbol] | | | | |
| [symbol] Capacity for Capsules [symbol] | [symbol] 2.58 [symbol] 2.58 [symbol] on a | | | |
| [symbol] Capacity [symbol] | [symbol] 15 power- [symbol] [symbol] | | | |
| Total Para [symbol] | | | | |

| [symbol] On Capacity [symbol] | [symbol] | 0.04 [symbol] 512 | 4 [symbol] 51163 |
|---|---|---|---|
| [symbol] Continu [symbol] | 3z,899; | 0.0 [symbol] 512 | 4. [symbol] 51163 |

[symbol]

indicates data missing or illegible when filed

An energy and mass balance calculation for an energy generation system according to an embodiment of the present invention is shown below in Table 3.

TABLE 3
Energy and Mass Balances for the 1 MWe capacity power generation:

| | Power | Units | |
|---|---|---|---|
| IN | | | |
| Reverse-Thrusters Actuator | 2.16 | kW (*) | >This Power is a parastic-lead. |
| PROD | | | |
| Work/Momentum of Weight | 2229.2 | Nm/s | >Weight on Free-Falls @72 degrees; Power-Cycle (360 |
| | | | degrees) by Five (5) Capsules. |
| Tot. M of Weight at t period | 5573.015 | Nm | >Total Work-done; Work and Velocity = Power; |
| | | | Power on time = Energy |
| Mechanical Energy | 1496.38 | HP | >Total Mechanical Energy Generated. |
| Electrical Power | 1114.807 | kW | >Total Energy in Electrical Power. |
| Bouyancy Pres. on Weight | 442.761 | kW | >Total Power Equivalent to lift Weight by Bouyancy Force; |
| | | | Gas-Density-Gradients raise accelerations & less drag. |
| Pressure Gradients at Base | 85.32 | kW | >Pressure-Gradient-Force available at Base-Reservoir to |
| | | | overcome the Pressure on top of Capsule's Piston-Disc. |
| Pressure Gradients at Top | 32.02 | kW | >Pressure-Gradient-Force available at Capsule's Piston- |
| | | | Disc to expell air/gas to Top-Reservior |
| TOTAL INPUT = IN + PROD = | 1675.908 | kW | >The available Power Output (excluding ACC) = 1114.807 kW |
| Drag Losses Allowed = N/A | | | |
| Mech. & O/All Efficiency @85% | 167.22105 | including (*) | |
| OUTPUT = OUT + ACC | | | (**) = ACC is approximately = 100,33263 kW |
| (Excluding ACC factors) | 947.58595 | kW (**) | ***POWER GENERATING CAPACITY NOMINAL 1000 |
| | | | kW or 1 MWe; Electricity for about 675 homes. |

The Engineering Computations and Designs Specifics are: Capacity based on One (1) Capsule Rating; Total System consists of Five (5) operating Capsules and One (1) Stand-by.
Downwards Power-Strokes Cycle (360 degrees) @72 degrees Operation-Logic. Power Strokes Full-Cycle (360 deg) @t = 11 sec; PS@t = ~2.5 sec.
Mass (Force-ma) = 23 kg in Dry-Chamber Free-Falls; Tower Height = 25 meters; Base-Reservior Piston 320 mm (0.32 m) diameter × Stroke Length = 355 mm (0.355 m).
Bouyant Volume = 28liters (0.0284 m3) provides ~25% greater capacity for bouyant at ~11 seconds including air/gas transfers from Base-Reservior to Capsule-Bouyant.
Friction Losses and Drag allowance at Full × 50% on Drag and Overall-Cycle efficiency at 65% on Mechanical.
Actuators for Main-Reverse Thrusters on AC motor; and Valves are Low-Voltage 12 VDC to max of 12 Amps on pulse-power signals.
Main Drive Gear RPM = 1910 RPM at 5573.015 Nm; Velocity of Mass 10 m/s at t = 2.5 seconds.
Base-Reservoir Reverse-Thruster operates at t = 3.3 seconds along the Reverse-Thruster length of 355 mm (0.355 m);
Piston Head Pressures @ 20 kN (2161 Nm/s = 2161 [symbol] /s = 2161 W = 2.161 kW)
Liquid Medium applied normal water = 1,010 kg/m3 (ie 1 m3 volume of water displaced, can hold 1,010 kg of weight - as in boat design for bouyancy);
Water Pressures = 10 kN/m2 per meter of water-depth; Bouyancy 1,010 kg/m3 of volume displaced;
Pressures-Gradients-Force between Base-Reservoir to the Capsule at Docking Station is 3,825N.
Pressures-Gradients-Force between the Capsule Piston-Disc to Top-Reservoir is 2,535N; air exits with minimal or no friction for fast/rapid-capsizing. [symbol]
indicates data missing or illegible when filed

In a further aspect, the invention resides broadly in an energy generation system comprising guide means, power generation means including at least one work shaft associated with said guide means, buoyant means associated with said guide means, and means for adding and/or removing a fluid to and/or from said buoyant means to cause movement of the buoyant means, and wherein rotation of the at least one work shaft is effected by movement of the buoyant means in a direction substantially perpendicular to the at least one work shaft.

In another aspect of the invention there is provided an energy generation system comprising a vessel, the vessel being at least partially filled with a first fluid, guide means, power generation means including at least one work shaft associated with said guide means, buoyant means associated with said guide means, means for adding and/or removing a second fluid to and/or from said buoyant means, the second fluid having a density different to that of the first fluid, and wherein rotation of the at least one work shaft is effected by movement of the buoyant means in a direction substantially perpendicular to the at least one work shaft.

As stated, the buoyant means is associated with the guide means. The buoyant means may be associated with the guide means in any suitable manner. However, in a preferred embodiment of the invention, the buoyant means is constructed to be substantially cylindrical, toroidal or any other similar shape with a hollow central passageway. In this embodiment, the guide means may be adapted to pass through a hollow central passageway in the buoyant means. Alternatively, the buoyant means may be provided with one or more connection means adapted to connect the buoyant means to the guide means. The connection means may be fixedly attached to the buoyant means, the guide means, or both. Preferably, however, the connection means are adapted to allow movement of the guide means and the buoyant means relative to one another in at least one direction. The connection means may be of any suitable configuration. For instance, the connection means may comprise a substantially cylindrical, toroidal or similar shape with a hollow central passageway through which the guide means may pass. Alternatively, the connection means may comprise any suitable form for at least temporarily and removably clamping or clipping the buoyant means to the guide means.

The guide means may be of any suitable type or configuration. For instance, the guide means may comprise fixed means, movable means, or a combination thereof. In some embodiments of the invention, the guide means may comprise at least one elongate member extending from at or adjacent the upper limit of travel of the buoyant means to at or adjacent the lower limit of travel of the buoyant means. The elongate member may be of any suitable form, such as, but not limited to, a chain, cable, wire or the like.

In some embodiments of the invention, the guide means may be associated with one or more storage devices (such as drums, spools, spindles or the like) onto which the guide means may be wound and/or unwound. Alternatively, the guide means may be provided in the form of an endless loop. In this embodiment of the invention, the guide means may be associated with one or more tracking devices adapted to ensure that the guide means tracks correctly around its loop. The tracking devices may be of any suitable form, such as, but not limited to, a pulley or the like. In a preferred embodiment of the invention, one tracking device is provided at the lower end of the guide means, while a second tracking device is provided at an upper end of the guide means.

In a preferred embodiment of the invention, at least one of said tracking devices may be adapted for movement, such as rotation, about an axis of the tracking device.

In some embodiments of the invention, at least one work shaft may be associated with the at least one rotatable tracking device. In this embodiment of the invention, rotation of the tracking device may result in rotation of the at least one work shaft. Preferably, the at least one work shaft is in communication with power generation means, such that rotation of the at least one work shaft results in the generation of power by the power generation means.

It is preferred that the at least one work shaft is disposed at an angle substantially perpendicular to the direction of movement of the buoyant means. As it is preferred that the direction of movement of the buoyant means is in a substantially vertical direction, it is therefore preferred that the at least one work shaft is disposed substantially horizontally.

In some embodiments of the invention, the buoyant means may be adapted for movement relative to the guide means in at least one direction. In another embodiment of the invention, movement of the buoyant means in at least one direction may result in a corresponding movement in the guide means. Preferably, the movement of the buoyant means results in a corresponding movement in the guide means in one direction only. In this embodiment of the invention, the guide means remains stationary when the buoyant means moves in a second direction. The direction of movement of the buoyant means that results in a corresponding movement of the guide means is not critical, although in a preferred embodiment of the invention, a downward movement of the buoyant means results in a corresponding movement of the guide means, while the guide means remains stationary when there is an upward movement of the buoyant means.

The corresponding movement of the guide means may be achieved using any suitable technique. Preferably, the buoyant means (or the connection means where present) is provided with engagement means adapted to engage the guide means as the buoyant means moves in one direction. Any suitable engagement means may be used, such as, but not limited to, one or more clamps, clips, ratchets or the like, or any combination thereof. Preferably, the engagement means is adapted to engage with the guide means when the buoyant means moves in one direction only. Thus, it is preferred that the engagement means comprises one or more ratchets.

When the movement of the buoyant means results in a corresponding movement of the guide means, the guide means may be forced to move around its loop. As the guide means moves in its loop, the movement of the guide means causes at least one of the tracking devices to rotate. The rotatable tracking device is preferably associated with the at least one work shaft, meaning that rotation of the tracking device causes the at least one work shaft to rotate, thereby transferring the movement to the power generation apparatus and resulting in the generation of power. Preferably, the rotatable tracking device is provided with gripping means for producing an improved grip between the tracking device and the guide means, thereby ensuring that the tracking device rotates as the guide means moves.

The first and second fluids may be any suitable fluids, provided that the density of the second fluid is different to that of the first fluid. Typically, the density of the second fluid will be less than that of the first fluid, but it is to be appreciated that the difference in the respective densities of the fluid is useable to cause movement of the buoyant means. The first and second fluids may be liquids, gases or solutions, or a combination thereof. In a preferred embodiment of the invention, the first fluid is water (either fresh water or saltwater) and the second fluid is air.

The buoyant means may be of any suitable construction. However, it is preferred that the buoyant means is constructed so as to be buoyant when at least partially filled with the second fluid, and to be denser than the first fluid when the second fluid is removed. In this way, the buoyant means can be made to move both upwards, or downwards under gravity in the vessel depending on the quantity of the second fluid contained therein. The buoyant means may be constructed as a flexible, inflatable capsule or may be a rigid container, or it may be a combination of the two. Preferably, the buoyant means is shaped so as to reduce drag as it moves through the first fluid in the vessel. By controlling the movement of the buoyant means within the vessel, the rotation of the shaft can be maintained substantially continuously if required, meaning the power may be generated on a continuous basis by the power generation means. In a preferred embodiment of the invention, the size of the buoyant means is determined in accordance with buoyancy formulae based on, for instance, surface area, and the density of the first fluid.

Downward movement of the buoyant means in the vessel may be achieved under gravity. However, in some embodiments of the invention, the buoyant means is provided with weights, such as ballast, to assist in generating a downwards movement of the buoyant means through the vessel. The weights may be of any suitable type, although in some embodiments of the invention, the weights are constructed of stainless steel, or similar corrosion-resistant materials, due to their exposure to the first fluid contained within the vessel. In some embodiments of the invention, the weights may form part (or all) of the base of the buoyant means. The mass of the weights may be determined by the torque required to actuate an alternator and therefore generate electricity. Therefore, the energy generation or capture may occur through rotation of the at least one work shaft in both directions. Thus, movement of the buoyant means either upwards or downwards may result in the generation or capture of energy by the at least one work shaft.

In some embodiments of the invention, the buoyant means is provided with locating means for assisting with the smooth movement of the buoyant means relative to the guide means. The locating means may be any suitable means, such as a pole, cable, chain or the like located parallel to the guide means. Preferably, the buoyant means is provided with engagement means of any suitable form adapted to engage the locating means and assist in the smooth movement of the buoyant means. The engagement means may be constructed from any suitable material. However, it is preferred that the engagement means are adapted to be corrosion resistant. Furthermore, it is preferably that the engagement means are either lubricated or self-lubricating. Thus, in a preferred embodiment of the invention, the engagement means may be fabricated from high density plastic suitable for marine environments. In a preferred embodiment of the invention, the locating means are constructed from a corrosion resistant material. Any suitable material may be used, such as, but not limited to, stainless steel.

In some embodiments of the invention there may be a plurality of buoyant means associated with one or more guide means.

Control of the operation of the energy generation system may be achieved using any suitable technique. For instance, the operation of the energy generation system may be controlled manually. In preferred embodiments of the invention, the operation of the energy generation system may be controlled using suitable automatic means. In some embodiments of the invention, the energy generation system may be provided with an electronic control system, such as a Distributed Control System (DCS). In this embodiment of the invention, it is preferred that the electronic control system is provided with one or more user interfaces. The user interfaces may be of any suitable form, such as, but not limited to, one or more screens, control panels, instrument panels, keyboards or the like, or any combination thereof. Preferably, the user interfaces includes means (e.g. buttons, switches, levers or the like) to allow a user to override automatic control of the system, and perform certain functions, such as, but not limited to, starting, stopping or resetting the system.

Preferably, in embodiments of the invention in which an automatic control system is used, it may be possible to switch the system between automatic and manual control modes.

The automatic control system may be powered using any suitable power source, such as, but not limited to, mains power, generators, batteries or the like, or any combination thereof. In some embodiments of the invention, at least a portion of the power used to control the automatic control system may be generated by the energy generation system.

In embodiments of the invention in which a control system is used, it may be necessary to provide cables (such as electrical wiring or the like) that extend from outside the vessel into the interior of the vessel. In this embodiment of the invention, it is preferred that the cables may be embedded in the walls and/or base of the vessel to ensure the apparatus remains watertight and that no fluid may leak into or out of the vessel.

In yet another aspect, the invention resides broadly in an energy generation system comprising a vessel, the vessel being at least partially filled with a first fluid, one or more compartments located within the vessel wherein the first fluid is prevented from entering the one or more compartments, guide means, power generation means including at least one work shaft associated with said guide means, the at least one work shaft being located at least partially within the one or more compartments, buoyant means associated with said guide means, means for adding and/or removing a second fluid to and/or from said buoyant means, the second fluid having a density different to that of the first fluid, and wherein rotation of the at least one work shaft is effected by movement of the buoyant means in a direction substantially perpendicular to the at least one work shaft.

In some embodiments of the invention the guide means may be provided with one or more means for increasing the rotational speed of the work shaft. Any suitable means may be used. In a preferred embodiment of the invention, the guide means is provided with one or more weights. Preferably, the one or more weights are located in the one or more compartments. Thus, as the guide means moves, the mass of the one or more weights results in an increased velocity of the movement of the guide means, thereby increasing the rotational speed of the work shaft. The movement of the one or more weights may be controlled or may be a free-fall (or approaching free-fall once the drag of the movement of the buoyant means through the first fluid is taken into account). However, in general the drag of the buoyant means is minimized as the second fluid is removed from the buoyant means under the pressure of the first fluid.

In addition, the movement of the one or more weights may also result in the activation of one or more devices, such as compressors. Any suitable compressor may be used. The pressures generated by the one or more devices may be stored then released at a suitable time onto any suitable rotational or electricity generation device (e.g. a turbine).

In some embodiments of the invention, a plurality of buoyant means may be provided.

In all aspects and embodiments of the invention described herein, the power generation means may be located at any suitable point within the system. In some embodiment of the invention, the power generation means may be located in an upper region of the system (for instance, at the upper end of the vessel, or even above the vessel). Alternatively, the power generation means may be located in a lower region of the system (for instance, at the lower end of the vessel, or even below the vessel). A benefit in locating the power generation means in a lower region of the vessel (say, at ground level) is a reduction in the support structures required for the power generation means, as well as increased ease of access to the power generation means for maintenance purposes and the like.

### BRIEF DESCRIPTION OF THE DRAWINGS

An embodiment of the invention will be described with reference to the following drawings in which:

FIG. 1 illustrates a cross-sectional view of an energy generation system according to an embodiment of the present invention;

FIG. 2 illustrates a detailed view of the buoyant means according to an embodiment of the present invention;

FIG. 3 illustrates a detailed view of the first reservoir according to an embodiment of the present invention;

FIG. 4 illustrates a detailed view of the first reservoir according to an alternative embodiment of the present invention;

FIG. 5 illustrates a cross-sectional view of an energy generation system according to an embodiment of the present invention;

FIG. 6 illustrates a cross-sectional view of an energy generation system according to an alternative embodiment of the invention;

FIGS. 7-8 illustrate a work shaft and gear according to an embodiment of the present invention;

FIG. 9 illustrates a power generation system according to an alternative embodiment of the present invention;

FIGS. 10-12 illustrate a reciprocating ram assembly according to an embodiment of the present invention;

FIG. 13 illustrates a rotor/stator assembly according to an embodiment of the present invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

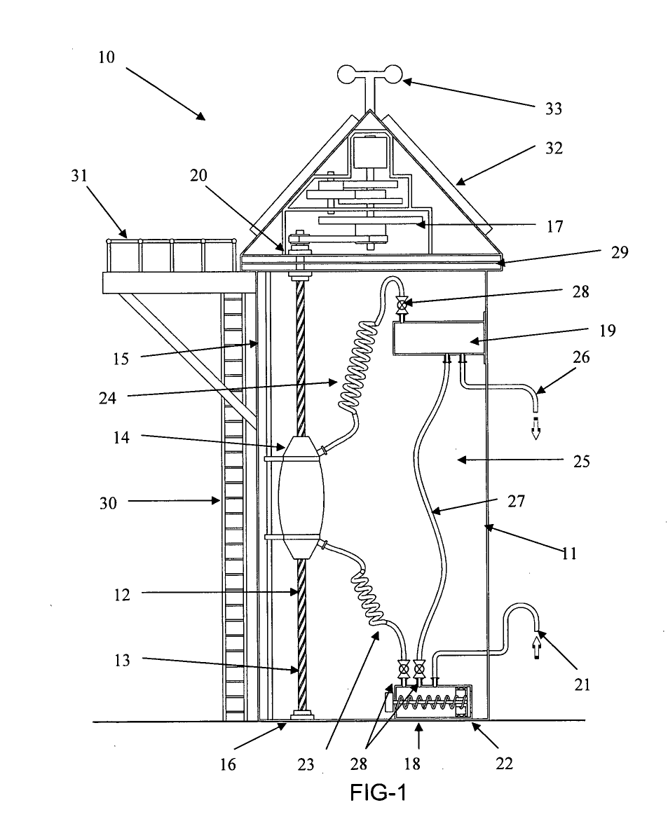

In FIG. 1 there is shown an energy generation system 10 according to an embodiment of the present invention. The energy generation system 10 comprises a vessel 11 in the form of a water tank and a shaft 12 rotatable about a longitudinal axis. The shaft 12 is provided with a helical screw shape 13. The shaft is connected at its lower end to a bearing 16 that allows the shaft 12 to rotate freely about its longitudinal axis. At the upper end, the shaft 12 is connected to power generation means 17 in the form of a flywheel system. The rotational energy of the shaft 12 may be transferred to the power generation means 17 through the use of a ratchet-cog system 20.

Buoyant means 14 in the form of an inflatable capsule is provided associated with the shaft 12. The buoyant means 14 is provided with guide means 15 in the form of a wire or pole to assist in the smooth movement of the buoyant means 14 relative to the shaft 12.

The system 10 is provided with a first reservoir 18 located in a lower portion of the vessel 11 and a second reservoir 19 located in an upper portion of the vessel 11. The first reservoir 18 draws air in through an air intake port 21 from the atmosphere. Once the pressure in the first reservoir has reached a predetermined value, a piston 22 is actuated, forcing air through a first hose 23 and into the buoyant means 14. When the buoyant means 14 is inflated with air from the first reservoir 18, it begins to move upwardly through the vessel 11, as the density of the air makes the buoyant means 14 less dense than the fluid 25 (such as fresh water or saltwater) in the vessel 11. This in turn causes rotation of the shaft 12, and the activation of the power generation means 17, thereby generating power.

When the buoyant means 14 reaches the upper limit of its travel, air in the buoyant means 14 may be forced to flow through a second hose 24 and into the second reservoir 19. When air is removed from the buoyant means 14, the buoyant means 14 moves downwardly through the vessel 11 under gravity with the assistance of ballast (obscured). With the air removed from the buoyant means 14, the buoyant means 14 become more dense than the fluid 25 in the vessel 11, and therefore the buoyant means sink in the fluid 25. The downward movement of the buoyant means 14 causes rotation of the shaft 12, and the activation of the power generation means 17, thereby generating power.

Air stored in the second reservoir 19 may be vented to the atmosphere through a vent 26 if the pressure in the second reservoir 19 becomes too high. Alternatively, air may flow from the second reservoir 19 into the first reservoir 18 through a third hose 27 so that less air must be drawn into the first reservoir 18 when the buoyant means 14 reaches the lower limit of its travel and must once again be inflated with air from the first reservoir 18.

All hoses 23,24,27 are provided with non-return valves 28 to ensure that air may flow in one direction only through the system 10.

The vessel 11 may be provided with ventilation 29 as required. The vessel 11 may also be provided with access means in the form of stairs 30 and an access platform 31 so that maintenance may be carried out on the system 10 as required.

The system 10 may further be provided with a solar energy collection device 32 to generate at least a portion of the energy required to drive the piston 22 and the non-return valves 28. Energy produced by the solar energy collection device 32 may also be used to power a light or beacon 33 to indicate the location of the system 10.

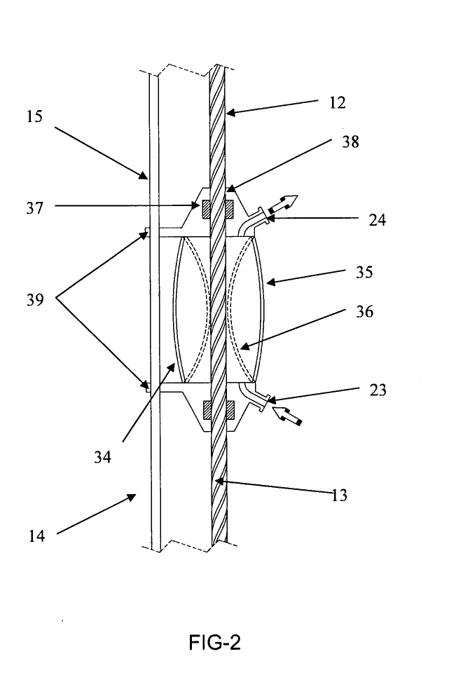

In FIG. 2 there is shown the buoyant means 14 according to an embodiment of the present invention. The buoyant means 14 comprises an inflatable capsule 34. This figure illustrates the shape of the walls of the inflatable capsule 34 when inflated 35 and when deflated 36. Air passes into the capsule 34 through a hose 23 and exits the capsule through a hose 24.

The buoyant means 14 further comprises a sleeve 37 attached to the capsule 34 and provided with projections (obscured) for engaging the helical screw 13 of the shaft 12, thereby causing rotation of the shaft 12 as the buoyant means 14 moves relative to the shaft 12. The sleeve 37 is provided with ballast 38, such as stainless steel weights that assist in the downward movement of the buoyant means 14 when the capsule 34 is deflated.

The buoyant means 14 is associated with guide means 15 in the form of a pole. The buoyant means 14 comprises a pair of engagement means 39 that engage the guide means 15 and assist in the smooth movement of the buoyant means 14 relative to the shaft 12.

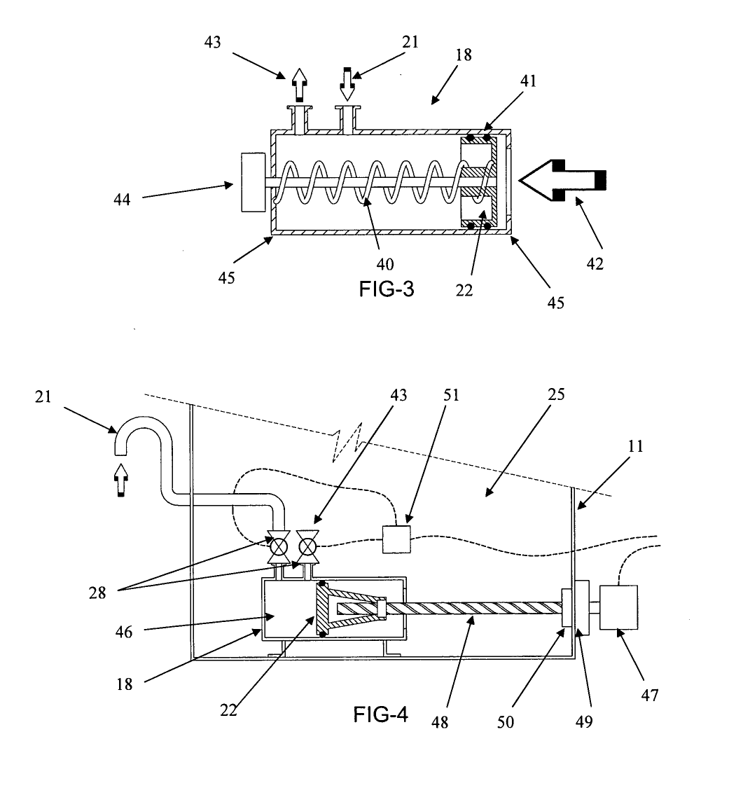

In FIG. 3 there is shown the first reservoir 18 according to one embodiment of the present invention. Air is drawn into the reservoir 18 through air intake 21. The reservoir 18 includes a piston 22 associated with a spring 40, the piston 22 being provided with seals 41 to prevent leakage of fluid.

When pressure, such as hydrostatic pressure is applied in the direction of arrow 42, the piston moves to the left of the reservoir 18 compressing the spring 40 and forcing fluid out through a fluid outlet 43. A motor 44 is provided to reverse the movement of the piston 22.

The reservoir 18 may be fixed to the floor of the vessel (not shown) using fixation means 45.

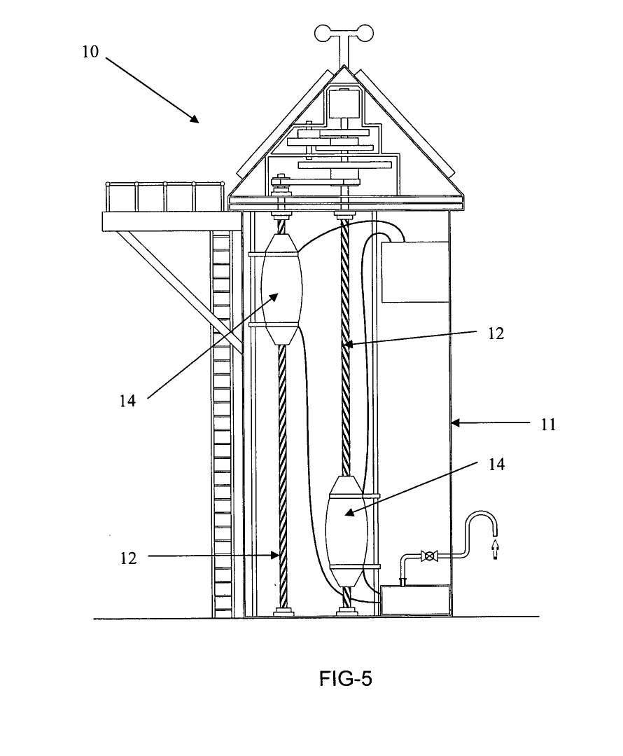

An alternative construction of the first reservoir 18 is shown in FIG. 4. In this embodiment of the invention, the reservoir 18 is housed within a vessel 11 containing a first fluid 25. air enters the reservoir 18 through air intake 21 and is held in a chamber 46 within the reservoir 18. The reservoir includes a piston 22 and movement of the piston 22 towards the left of the reservoir 18 forces air in the chamber 46 out through air outlet 43.

Movement of the piston 22 is achieved by the actuation of a motor 47 which drives the rotation of a shaft 48, the shaft being provided with a helical screw on its outer surface. The motor 47 transfers rotational energy to the shaft 48 through a ratchet and cog mechanism 49. The mechanism 49 is provided with a spring loaded seal 50 on the inner surface of the vessel 11.

An actuator 51 may be used to control the opening and closing of non-return valves 28 and also the actuation of the motor 47.

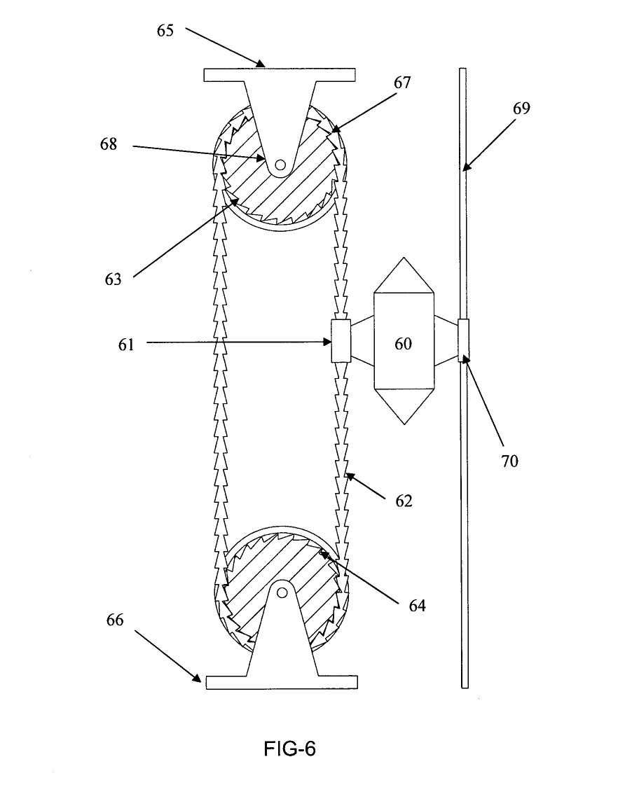

In FIG. 5 there is shown an energy generation system 10 according to an embodiment of the present invention in which a pair of buoyant means 14 are present. Each of the buoyant means 14 is associated with its own shaft 12 and may move upwardly and downwardly in the vessel 11 independently of one another.

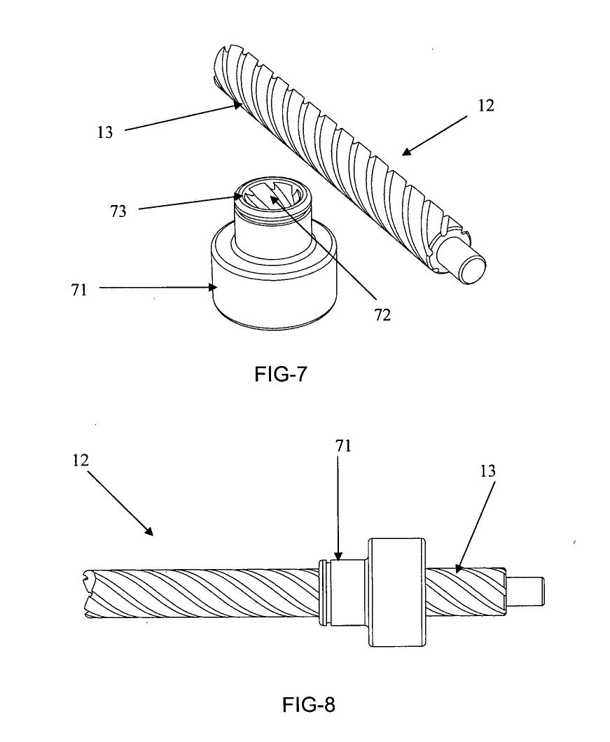

In FIG. 6, an alternative embodiment of the present invention is illustrated. In this embodiment of the invention, the buoyant means 60 comprises connection means 61 in the form of a cylindrical sleeve through which the guide means 62 in the form of a chain passes. The chain 62 is provided in an endless loop and is located on an upper tracking device 63 and a lower tracking device 64. Both the upper tracking device 63 and the lower tracking device 64 are in the form of pulleys. The upper tracking device 63 may be fixed to an upper wall (not shown) of a vessel (not shown) via a bracket 65, while the lower tracking device 64 may be fixed to a lower wall (not shown) of a vessel (not shown) via a bracket 66.

The connection means 61 is provided with engagement means (obscured) in the form of ratchets which engage with the links of the chain 62 when the buoyant means 60 moves in a downward direction. Thus, as the buoyant means 60 moves downwards, the chain 62 also moves, thereby causing both the upper 63 and lower 64 tracking devices to rotate in a clockwise direction. The upper 63 and lower 64 tracking devices are provided with a series of indentations 67 corresponding to the shape of the links of the chain 62. In this way, the chain 62 sits in the indentations 67 and grips the tracking device (63, 64), thereby ensuring that the tracking device (63, 64) rotates.

In the embodiment of the invention illustrated in FIG. 5, a work shaft 68 is associated with the upper tracking device 63 such that rotation of the upper tracking device 63 results in rotation of the work shaft 68. The work shaft 68 is located substantially perpendicular to the direction of travel of the buoyant means 60. The work shaft 68 is associated with power generation means (not shown) such that the rotation of the work shaft 68 is transferred to the power generation means (not shown), thereby resulting in the generation of power.

In this embodiment of the invention, locating means 69 in the form of a cable may be provided. The buoyant means 60 may be associated with the locating means 69 by a second connection means 70, through which the cable 69 passes. The cable 69 serve to ensure the smooth movement of the buoyant means 60.

In FIGS. 7 and 8, a shaft 12 and gear 71 are illustrated. The shaft 12 is provided with a helical screw shape 13, while the gear 71 is provided with a bore 72 having a plurality of projections 73 adapted to align with the helical channels in the surface of the shaft 12. In use, the shaft 12 projects through the bore 72 (as shown in FIG. 8) and the gear 71 is adapted for connection to the buoyant means (not shown) such that movement of the buoyant means causes the projections 73 to engage with the helical channels, thereby causing the shaft 12 to rotate as the buoyant means moves relative to the shaft 12.

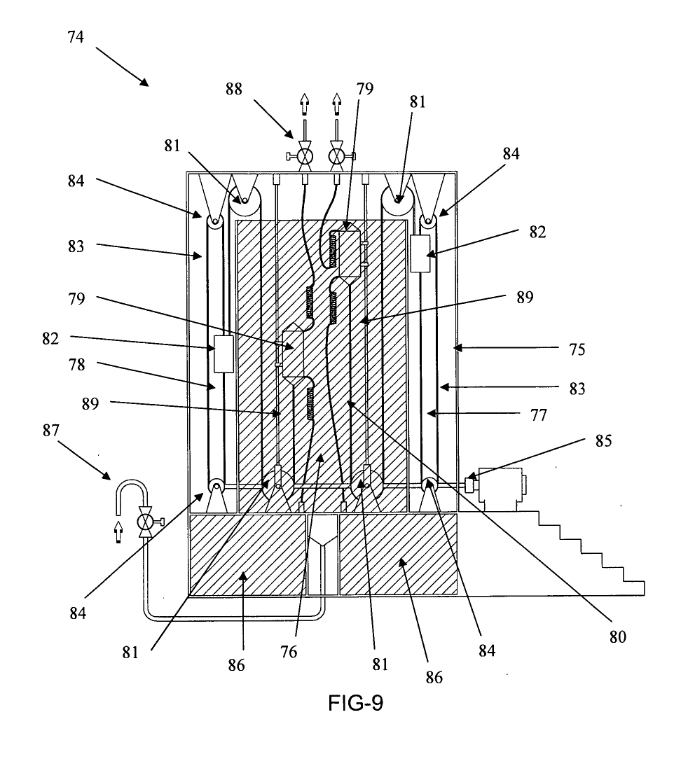

FIG. 9 illustrates an energy generation system 74 according to an alternative embodiment of the present invention. The system 74 comprises a vessel 75 having a “wet” compartment (i.e. fluid-filled) 76 and one or more “dry” compartments (in this case, a pair of dry compartments 77, 78) with no fluid therein. The dry compartments may be either formed integrally with the vessel 75 or may be formed separately and fitted thereto. The dry compartments may be fabricated from any suitable material, such as, but not limited to, concrete, steel, fiberglass, plastic or any combination thereof.

The system 74 further comprises a pair of buoyant means 79 having a deflatable bladder-like construction. The buoyant means 79 is associated with guide means 89 which ensure that the buoyant means 79 move smoothly in upwards and downwards within the vessel 75.

In the embodiment of the invention illustrated in FIG. 9, the fluid reservoirs 86 are located in the base of the vessel 75. Fluid in the form of air enters the reservoirs 86 through inlet 87, while fluid exiting the buoyant means 79 is vented through valves 88. The vented fluid may either be expelled to the atmosphere or recycled to the reservoirs 86.

Each of said buoyant means 79 is adapted for connection to one end of a chain or rope 80. A weight 82 is connected to the other end of the chain or rope 80. The chain or rope 80 is associated with a series of pulleys 81 such that when the buoyant means 79 is inflated and filled with liquid, the buoyancy of the buoyant means 79 is greater than the mass of the weight 82 and the buoyant means 79 rises in the vessel. When the buoyant means 79 is deflated, the mass of the weight 82 is greater than the buoyancy of the buoyant means 79 and the buoyant means 79 sinks in the vessel 75.

In the embodiment of the invention illustrated in FIG. 9, the weights 82 are located in the dry compartments 77,78. There are several reasons for this, including that, by locating the weights 82 in the dry compartments 77,78, the velocity of the weights 82 in the downward direction is increased, and therefore an increase in the energy produced by the system 74 is experienced.

The weights 82 are associated with second ropes or chains 83, such that vertical movement of the weights 82 results in the rotation of the second ropes or chains 83 around a pair of sprockets 84. Rotational energy generated by the rotation of the second ropes or chains 83 is transferred to a power generation device 85 (such as a turbine or the like) in order to generate power (e.g. electrical power).

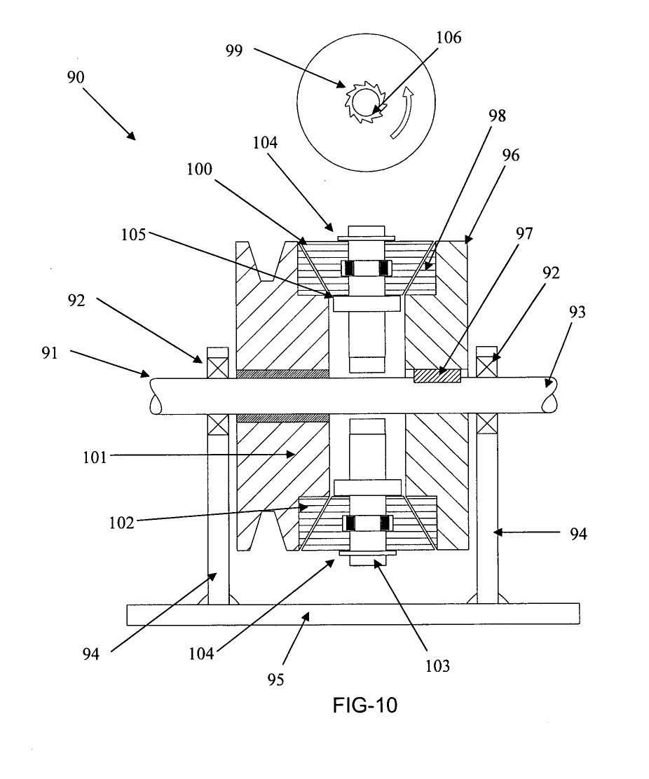

In FIG. 10, a reciprocating ram assembly 90 according to an embodiment of the present invention is illustrated. The reciprocating ram assembly 90 comprises a common shaft 91 held in position by bearings 92. One end 93 of the shaft 91 is adapted for connection to a device for imparting rotation (not shown) such as a motor or the like. The shaft 91 is held in position on supports 94 and base 95. A drive wheel 96 is fixed to the shaft 91 via a key 97. The drive wheel 96 has gears 98 to match the gear on the interface wheel 100. A delivery wheel 101 with gear 102 matching those of the drive wheel 96 is also a provided, with the delivery wheel 101 and the drive wheel 96 being either rotatable or fixed on the shaft 91.

The interface wheel 100 is located on a second shaft 103 having clips 104 to hold the wheels in position and a stopper 105. The shaft 103 is fitted with ratchet assembly pins 106 that engage with recesses 99. The shaft 103 engages the wheels when the shaft 103 rotates anti-clockwise. Similarly, the shaft 103 disengages from the recesses 99 when the shaft 103 rotates clockwise. Movement of the wheels is caused by the rotation of the drive wheel 96. When under no load, the delivery wheel 101 is free to rotate on the drive wheel 96 via the interface wheel 100. However, when torque is applied to the drive wheel 96, the interface wheel 100 is engaged and engages the delivery wheel 101 to turn in the same direction as the drive wheel 96. Preferably, the power to drive the assembly 90 is parasitic.

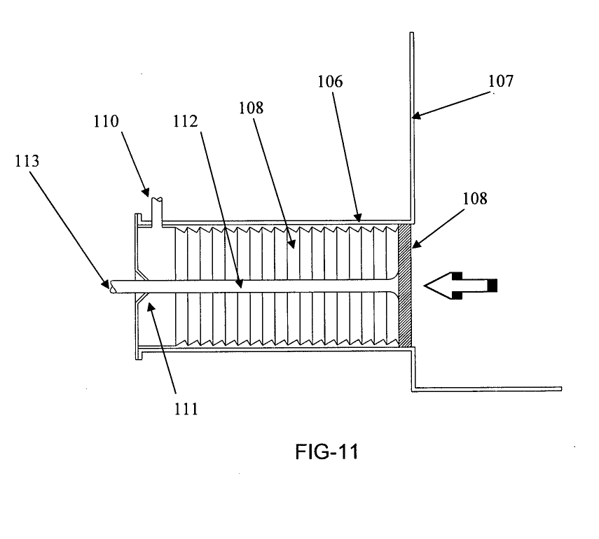

In FIG. 11, a reservoir 106 is illustrated when installed at the exterior of (and at the base of) a vessel 107. The reservoir 106 comprises a piston disc 108 that moves freely within the reservoir 106. The piston disc 108 is attached to a set of bellows 109 that may be compressed to pressurize air that exits the reservoir trough outlet 110 and to allow the ingress of air through one way valve 111 when the piston disc 108 is extended by the drive rod 112 which is connected to or driven by the reciprocating ram illustrated in FIG. 10 at point 113.

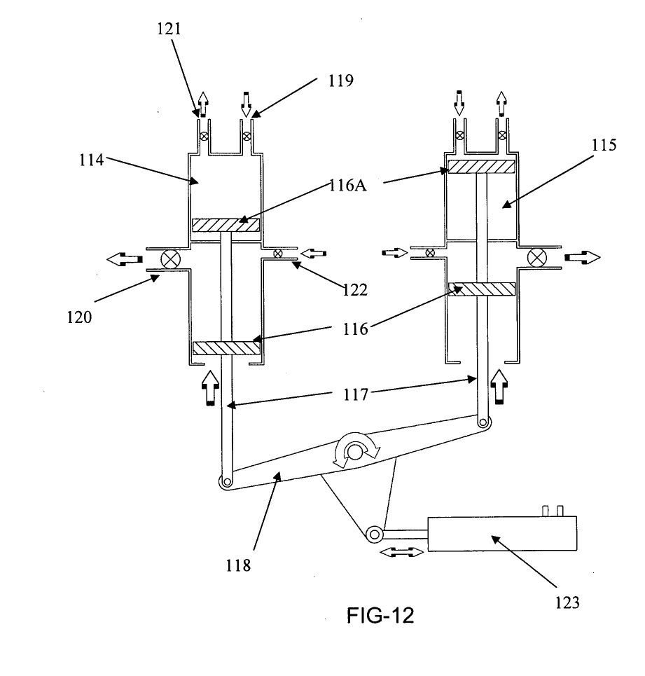

In FIG. 12, a first reservoir 114 and second reservoir 115 are illustrated. These reservoirs 114, 115 are located at the base of a vessel (not shown). Each reservoir 114, 115 is provided with a pair of piston discs 116, 116A connected to a drive rod 117. In turn the drive rods 117 are connected to a reciprocating ram 118. The pair of pistons discs 116, 116A effectively divides each reservoir 114, 115 into two chambers, each of which may be adapted to hold the same or a different fluid.

Actuation of the reciprocating ram 118 to force the piston discs 116, 116A downwardly in the first reservoir 114 draws fluid in through a first inlet 119 and simultaneously through a second outlet 120, while an upwards movement of the piston discs 116, 116A forces fluid out of the reservoir 114 through a first outlet 121 and simultaneously into the reservoir 114 through a second inlet 122. A similar arrangement exists in the second reservoir 115.

The reciprocating ram 118 may be powered by a hydraulic ram 123. Preferably, the hydraulic ram 123 only provides a portion of the power to the reciprocating ram 118. Preferably, the reciprocating ram 118 may be powered using parasitic power.

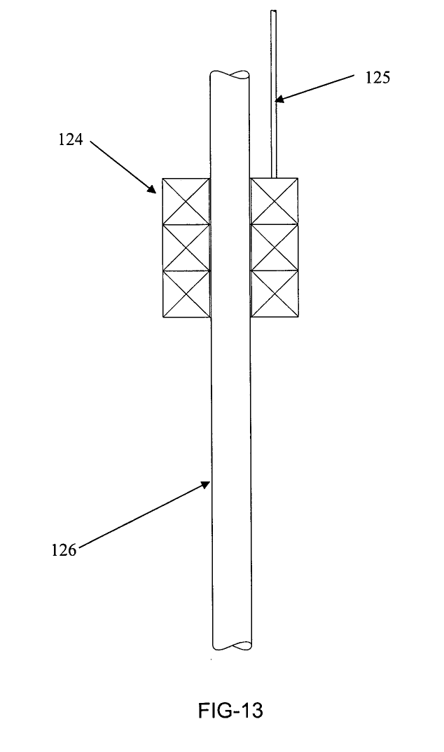

In FIG. 13 there is shown a rotor/stator assembly according to an embodiment of the present invention. In this embodiment of the invention the buoyant means (not shown) is connected to a rotor 124 via a cable 125. The rotor 124 acts as ballast such that when fluid is removed from the buoyant means (not shown), the weight of the rotor 124 causes the buoyant means to sink. Thus, as the rotor 124 moves downwards relative to the stator shaft 126, an electrical current is generated.

Similarly, when the buoyant means (not shown) is inflated, the buoyancy of the buoyant means (not shown) is greater than the weight of the rotor 124 and the buoyant means (not shown) rises. As the rotor 124 moves upwards relative to the stator shaft 126, an electrical current is generated.

Those skilled in the art will appreciate that the present invention may be susceptible to variations and modifications other than those specifically described. It will be understood that the present invention encompasses all such variations and modifications that fall within its spirit and scope.

1. An energy generation system comprising at least one shaft, inflatable buoyant means associated with, and movable relative to, said at least one shaft, wherein movement of the inflatable buoyant means along a longitudinal axis of the at least one shaft causes rotation of the at least one shaft about the longitudinal axis, means for adding and/or removing a fluid to and/or from said inflatable buoyant means to cause movement of the inflatable buoyant means, and power generation means associated with said at least one shaft.

2. An energy generation system comprising a vessel, the vessel being at least partially filled with a first fluid, at least one shaft positioned substantially vertically within said vessel, inflatable buoyant means associated with, and movable relative to, said at least one shaft, wherein movement of the inflatable buoyant means along a longitudinal axis of the at least one shaft causes rotation of the at least one shaft about the longitudinal axis, means for adding and/or removing a second fluid to and/or from said inflatable buoyant means, the second fluid having a density different to that of the first fluid, and power generation means associated with said at least one shaft.

3. An energy generation system according to claim 1 wherein rotation of the at least one shaft about a longitudinal axis results in the generation of power by the power generation means.

4. An energy generation system according to claim 2 wherein the density of the second fluid is less than that of the first fluid.

5. An energy generation system according to claim 2 wherein the first fluid is water and the second fluid is air.

6. An energy generation system according to claim 1 wherein addition of the fluid to the inflatable buoyant means causes the inflatable buoyant means to rise in the vessel, while removal of the fluid from the inflatable buoyant means causes the inflatable buoyant means to sink in the vessel.

7. An energy generation system according to claim 1 wherein the inflatable buoyant means comprises a hollow central passageway through which the shaft is adapted to pass.

8. An energy generation system according to claim 1 wherein the at least one shaft is provided with one or more helical channels on the outer surface thereof.

9. An energy generation system according to claim 8 wherein the inflatable buoyant means comprises one or more projections adapted to engage the one or more helical channels on the outer surface of the at least one shaft.

10. An energy generation system according to claim 1 wherein the fluid(s) are stored in one more reservoirs.

11. An energy generation system according to claim 10 wherein the one or more reservoirs are in fluid communication with the inflatable buoyant means.

12. An energy generation system according to claim 1 wherein the system comprises two or more inflatable buoyant means.

13. An energy generation system comprising guide means, power generation means including at least one work shaft associated with said guide means, inflatable buoyant means associated with said guide means, and means for adding and/or removing a fluid to and/or from said inflatable buoyant means to cause movement of the inflatable buoyant means, wherein rotation of the at least one work shaft is effected by movement of the inflatable buoyant means in a direction substantially perpendicular to the at least one work shaft. and wherein movement of the inflatable buoyant means in a first direction results in a corresponding movement of the guide means, whereas a movement of the inflatable buoyant means in a second direction does not produce a corresponding movement of the guide means.

14. An energy generation system comprising a vessel, the vessel being at least partially filled with a first fluid, guide means, power generation means including at least one work shaft associated with said guide means, inflatable buoyant means associated with said guide means, means for adding and/or removing a second fluid to and/or from said inflatable buoyant means, the second fluid having a density different to that of the first fluid, wherein rotation of the at least one work shaft is effected by movement of the inflatable buoyant means in a direction substantially perpendicular to the at least one work shaft, and wherein movement of the inflatable buoyant means in a first direction results in a corresponding movement of the guide means, whereas a movement of the inflatable buoyant means in a second direction does not produce a corresponding movement of the guide means.

15. An energy generation system according to claim 13 wherein the inflatable buoyant means comprises a hollow central passageway through which the guide means is adapted to pass.

16. An energy generation system according to claim 13 wherein the guide means comprises an elongate member.

17. An energy generation system according to claim 16 wherein the elongate member is a chain, cable, wire or the like.

18. An energy generation system according to claim 13 wherein the guide means is associated with one or more rotatable tracking means, such that movement of the guide means results in the rotation of the one or more rotatable tracking means.

19. An energy generation system according to claim 18 wherein the rotatable tracking means is adapted for connection to the work shaft such that rotation of the rotatable tracking means results in the rotation of the work shaft.

20. An energy generation system comprising a vessel, the vessel being at least partially filled with a first fluid, one or more compartments located within the vessel wherein the first fluid is prevented from entering the one or more compartments, guide means, power generation means including at least one work shaft associated with said guide means, the at least one work shaft being located at least partially within the one or more compartments, buoyant means associated with said guide means, means for adding and/or removing a second fluid to and/or from said buoyant means, the second fluid having a density different to that of the first fluid, and wherein rotation of the at least one work shaft is effected by movement of the buoyant means in a direction substantially perpendicular to the at least one work shaft.

21. An energy generation system according to claim 20 wherein the guide means are provided with one or more means for increasing the rotational speed of the work shaft.

22. An energy generation system according to claim 21 wherein the one or more means for increasing the rotational speed of the work shaft comprise weights.

23. An energy generation system according to claim 21 wherein the one or more means for increasing the rotational speed of the work shaft are located in the one or more compartments.

24. An energy generation system according to claim 23 wherein the movement of the one or more means for increasing the rotational speed of the at least one work shaft within the one or more compartments approaches free-fall.
